(19) United States
(12) Patent Application Publication
(10) Pub. No.: US 2015/0070876 A1
(43) Pub. Date: Mar. 12, 2015

(54) Multiple Function LED Projection Light Having Built-In Motor Means

(71) Applicant: Tseng-Lu Chien, Walnut, CA (US)

(72) Inventor: Tseng-Lu Chien, Walnut, CA (US)

(21) Appl. No.: 14/019,779

(22) Filed: Sep. 6, 2013

(51) Int. Cl. F21S 10/00

(52) U.S. Cl. CPC F21S 10/002; F21S 10/00
USPC 362/101

(57) ABSTRACT

The LED project Light of current invention consist of motor means, propeller means, 1^{st} magnetic means, 2^{nd} magnetic means, freely move base, LED(s), circuit means, control means, timer means, sensor means, trigger means, conductive means to make the propeller moved to make liquid/fluid/chemical/particles/solid pieces flow moving for pre-determined speed and direction(s) so inside staff will change position for moving function and also come out splendid light effects of Night light. The current invention do not has toxic liquid, heat means to make a big improvement for safety and prevent from fire hazard. Not only has moving fluid to make motion performance but also has the project light performance from one unit.

This filing related to co-inventor's prior patent application Ser. Nos.

U.S. Ser. No. 12/938,564, filed on Nov. 3, 2010, public on May 3, 2012, Pub #2012,0106-132, Jan. 9, 2013

Filed RCE cases for LED Lava light. The current invention is CIP filling for this co-pending filing.

The Current inventions also CIP of co-inventors U.S. Pat. No. 7,455,444 more than one LED Night light, U.S. Pat. No. 7,632,004 more than one optics means night light, U.S. Pat. No. 7,832,917 project Night light, U.S. Pat. No. 7,892,918 project Night light, U.S. Pat. No. 7,909,477 Aquarium Night light, U.S. Pat. No. 8,029,182 Aquarium Night light, U.S. Pat. No. 8,083,377 project Night light, U.S. Pat. No. 8,128,274 project Night light, U.S. Pat. No. 8,231,260 project Night light, U.S. Pat. No. 8,277,087 LED light more than one reflector means, U.S. Pat. No. 8,303,150 project LED light for Seasonal light, U.S. Pat. No. 8,303,158 LED light has special light effects, U.S. Pat. No. 8,408,736 LED light device has project light beams, U.S. Pat. No. 8,434,927 LED light has interchangeable power source. These issued patents still has a lot of CIP co-pending cases as below listed series number of parent of current invention.

The current invention is Continuously or Division filing for co-pending filing case as below which are mainly for

(A) Rotating LED light device has outlets or electric receiving sockets means US Co pending filing Ser. No. 12/950,017 filed on Nov. 19, 2010

(B) Electric device has build in Universal USB-unit(s) and Outlet-unit(s) US Co Pending Filing Ser. No. 13/117,227 filed on May 27, 2011

(C) Desk Top LED device has USB-unit(s) or Outlet-Unit(s) to charge electric or digital device US co pending filing U.S. Ser. No. 13/161,643 filed on Jun. 16, 2011

(D) Multiple Function LED night light U.S. Ser. No. 11/806,285 filed on May 31, 2007

And also CIP filing for the following LED related filing cases:
(1) Project light (2) More than one function (3) adjust focus (4) adjust angle (5) Elastic contact points (6) LED heat solution (7) Heat sensitive parts installation (8) extend means are disclosure all below listed co-pending and patented as prior arts still fall within the current invention as below:

U.S. Ser. No. 13/923,721, U.S. Ser. No. 12/910,295,U.S. Ser. No. 13/870,447, U.S. Ser. No. 13/870,253, U.S. Ser. No. 13/863,073, U.S. Ser. No. 13/858,064, U.S. Ser. No. 13/549,728, U.S. Ser. No. 13/402,247, U.S. Ser. No. 13/267,816, U.S. Ser. No. 13/367,758, U.S. Ser. No. 13/367,687, U.S. Ser. No. 13/296,508, U.S. Ser. No. 13/296,469, U.S. Ser. No. 13/295,301, U.S. Ser. No. 13/162,824, U.S. Ser. No. 13/161,643, U.S. Ser. No. 13/117,227, U.S. Ser. No. 13/021,107, U.S. Ser. No. 12/950,017, U.S. Ser. No. 12/948,953, U.S. Ser. No. 12/951,501, U.S. Ser. No. 12/938,564, U.S. Ser. No. 12/938,798, U.S. Ser. No. 12/938,628, U.S. Ser. No. 12/886,832, U.S. Ser. No. 12/876,507, U.S. Ser. No. 12/887,700, U.S. Ser. No. 13/021,124, U.S. Ser. No. 12/771,003, U.S. Ser. No. 12/711,456, U.S. Ser. No. 12/710,918, U.S. Ser. No. 12/710,561, U.S. Ser. No. 12/540,689, U.S. Ser. No. 13/534,611, U.S. Ser. No. 12/624,621, U.S. Ser. No. 13/295,562, U.S. Ser. No. 12/622,000, U.S. Ser. No. 13/019,331, U.S. Ser. No. 12/318,470, U.S. Ser. No. 12/914,584, U.S. Ser. No. 12/940,255, U.S. Ser. No. 12/318,473, U.S. Ser. No. 12/834,435, U.S. Ser. No. 12/292,153. U.S. Ser. No. 12/907,443, U.S. Ser. No. 12/232,505, U.S. Ser. No. 12/232,035, U.S. Ser. No. 12/149,963, U.S. Ser. No. 12/149,964, U.S. Ser. No. 12/073,095, U.S. Ser. No. 12/073,889, U.S. Ser. No. 12/073,809, U.S. Ser. No. 11/806,711, U.S. Ser. No. 11/806,285, U.S. Ser. No. 12/566,322, U.S. Ser. No. 11/498,874, U.S. Ser. No. 12/502,661,

The current invention is continuously filing for Ser. No. 13/295,301 “The Device has build-in Digital Data means and Powered by unlimited power source of light device”.

The current invention is continuously filing for Ser. No. 13/296, 508 “The Device has build-in Digital Data means and power unlimited power source of LED Bulb”

The current invention is continuously filing for Ser. No. 13/296,460 “The device has build-in Digital data means and powered by unlimited power source of Lamp Holder.

These (3) co-pending filing are continuously filing of 12-951, 501 “Lamp Holder has build-in LED Night light”

The current invention is continuously filing for Ser. No. 12/950,017 “Multiple surface LED light”

All these are continuously filing for Ser. Nos. 13,296,508, 13/295,301, 13/296,469 are continuously filing for Ser. No. 13/162,824 Light device with display means has track-means and removable LED-unit(s) which are the continuously filing for Ser. No. 12/938,628 LED light fixture has outlet(s) and removable LED unit(s) and for Ser. No. 12/887,700 Light fixture with self-power removable LED unit(s). Those are continuously filing for Ser. No. 12/149,963(Now patented U.S. Pat. No. 7,722,230), Ser. No. 12/073,095(Now U.S. Pat. No. 7,726,869), Ser. No. 12/073,889 (Co-Pending Filing), Ser. No. 12/007,076 (Now patented U.S. Pat. No. 7,726,841), Ser. No. 12/003,691 (Now Patented U.S. Pat. No. 7,726,839), Ser. No. 12/894,865 (Co-Pending Filing).

This is continuation of U.S. patent application Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11/527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156. 11/094,155. 10/954,189, 10/902,123, 10/883,719, 10/883,747, 10/341,519, 12/545,992, 12/292,580, 12/710,918, 12/624,621, 12/622,000, 12/318,471, 12/318,470, 12/318,473, 12/292,153, 12/710,561, 12/710,918, 12/711,456, 12/771,003

This is Division of U.S. patent application Series Ser. No. 13-xxx.xxx field on Nov. 11, 2011 for The Device has build-in digital data means and powered by unlimited power source for Lamp holder.

This is Division of U.S. patent application Series Ser. No. 13-xxx.xxx field on Nov. 11, 2011 for The Device has build-in digital data means and powered by unlimited power source for light Device.

This is continuously of U.S. patent application Series Ser. No. 12/951-501 field on Nov. 20, 2010 for Lamp Holder has build-in LED light.

This is continuously of U.S. patent application series Ser. No. 12/771,003 field on Apr. 29, 2010 for LED light has geomvetric-unit(s) incorporated project means.

This is continuously of U.S. patent application Sense Ser. No. 12/711,456 Field on Feb. 25 2010 for LED power failure Light

This is continuously of U.S. patent application Series Ser. No. 12/710,561 Field on Feb. 25, 2010 for LED light device has special effects

This is continuously filing of U.S. patent application Series Ser. No. 12/710,918 Field on Feb. 25, 2010 for LED light device has more than 1 reflective means for plurality of image

This is continuation of U.S. patent application series Ser. No. 12/624,621 Field on Nov. 24, 2009 file for the “project device or assembly for variety of LED light”

This is continuation of U.S. patent application series Ser. No. 12/622,000 Field on Nov. 24, 2009 file for the “Interchangeable Universal Kits for all LED light”

This is continuation of U.S. patent application series Ser. No. 12/318,471 Field Dec. 30, 2008 file for the “LED night light with pinhole imaging”

This is continuation of U.S. patent application series Ser. No. 12/318,470 Field Dec. 24, 2008 file for the “LED night light with Projection features”

This is continuation of U.S. patent application series Ser. No. 12/318,473 Field Dec. 8, 2008 file for the “LED night light with laser or hologram element”

This is continuation of U.S. patent application series Ser. No. 12/292,153 Field Nov. 8, 2008 file for the “LED night light with Projection or imageing features”

This is continuation of U.S. patent application series Ser. No. 12/232,505 Field Sep. 16, 2008 file for the “LED night light with Projection features”

This is continuation of U.S. patent application Series Ser. No. 12/149,963 Filed on Apr. 21, 2008 file for the “Removable LED light device.

This is continuation of U.S. patent application Series Ser. No. 12/149,964 Filed on Apr. 21, 2008 file for the “Surface Mounted device with LED light”.

This is continuation of U.S. patent application Series Ser. No. 12/073,095 Filed on Feb. 29, 2008 file for the “LED Track light device.

This is Continuation of U.S. patent application Ser. No. 12/073,889 filed on Feb. 12, 2008 file for the” LED light with changeable position with Preferable power source”.

This is Continuation of U.S. patent application Ser. No. 12/007,076, filed on Jan. 7, 2008 file for the “LED light with changeable geometric system”

This is Continuation of U.S. patent application which the Ser. No. 12/003,691, filed on Dec. 31, 2007 file for the “LED light with changeable geometric dimension features”

This is Continuation of U.S. patent application which the Ser. No. 12/003,809, filed on Jan. 2, 2008 file for the “LED light with changeable features”

This is Continuation of U.S. patent application which the Ser. No. 11/806,711 filed on Apr. 30, 2007 file for the “Multiple LED light with adjustable angle features”

This application is continuation of U.S. patent application Ser. No. 11/806,285. LED Night light with outlet device filed on Apr. 30, 2007

This application is continuation of U.S. patent application Ser. No. 11/806,284 LED Night light with more than 1 optics means filed on Apr. 28, 2007

This application is continuation of U.S. patent application Ser. No. 11/527,628. Multiple function Night light with air fresher filed on Sep. 27, 2006.

This application is continuation of U.S. patent application Ser. No. 11/527,629. LED

Night light with interchangeable display unit filed on Sep. 27, 2006.

This application is continuation of U.S. patent application Ser. No. 11/498,874. Area illumination Night light filed on Aug. 4, 2006.

This application is continuation of U.S. patent application Ser. No. 11/527,631. LED Time piece night light field on Sep. 27, 2006.

This application is continuation of U.S. patent application, Ser. No. 12/545,992 LED time piece Night light filed division of Ser. No. 11/527,631 on Aug. 24, 2009.

This application is continuation of U.S. patent application, Ser. No. 12/292,580 LED

Time Piece Night light filed division of Ser. No. 11/527,631 on 8-24, 2009.

This application is continuation of U.S. patent application Ser. No. 11/498,881, Poly Night light filed on Aug. 4, 2006.

This application is continuation of U.S. patent application Ser. No. 11/255,981, Multiple light source Night Light filed on Oct. 24, 2005.

This application is continuation of U.S. patent application Ser. No. 11/184,771 Light Device with EL elements field on Oct. 11, 2005

This application is continuation of U.S. patent application Ser. No. 11/1152,063 Outlet adaptor with EL field on Jun. 5, 2005

This application is continuation of U.S. patent application Ser. No. 11/094,215 LED night light with liquid medium filed on Mar. 31, 2005

This application is continuation of U.S. patent application Ser. No. 11/094,215, filed Mar. 30, 2005 LED Night light with Liquid optics medium.

This application is continuation of U.S. patent application Ser. No. 11/092,741, filed Mar. 30, 2005 Night light with fiber optics.

This application is continuation of U.S. patent application Ser. No. 10/883,747, filed Jul. 6, 2004 Fiber Optic light kits for footwear.

This application is continuation of U.S. patent application Ser. No. 11/498,874, Area Illumination for LED night light

This application is continuation of U.S. patent application Ser. No. 11/527,629. Time Piece with LED night light,

This application is continuation of U.S. patent application Ser. No. 11/527,628. Multiple Function Night light with Air Freshener

This application is continuation of U.S. patent application Ser. No. 11/806,284 LED

Night light with more than one optics mediums

This application is continuation of U.S. patent application Ser. No. 11/806,285 LED Night Light with multiple function

This application is continuation of U.S. patent application Ser. No. 11/806,711 Multiple LEDs Light with adjustable angle function

The current invention incorporate with above listed co-pending or patented cases' features, construction still fall within the current inventions scope and all realted equvalent function or replace parts also should fall within the current invention.

Ser. Nos. 12/624,621, 12/622,100, 12/318,471, 12/318,470, 12/318,473, 12/292,153, 12/232,505, 12/232,035, 12/149,963, 12/149,964, 12/073,095, 12/073,889, 12/007,076, 12/003,691, 12/003,809, 11/806,711, 11/806,285, 11/806,284, 11/566,322, 11/527,628, 11/527,629, 11/498,874, 12/545,992, 12/806,711, 12/806,285, 12/806,284, 12/566,322, 12/527,628, 12/527,629, 12/527,631, 12/502,661, 11/498,881, 11/255,981, 11/184,771, 11/152,063, 11/094,215, 11/092,742, 11/092,741, 11/094,156. 11/094,155, 10/954,189, 10/902,123, 10/883,719, 10/883,747, 10/341,519, 12/545,992, 12/292,580, 12/710,918, 12/622,000 12/710,561, 12/710, 12/711,456, 12/771,003

This is patent application related to co-inventor's prior filing Ser. No. 12/771,003 Filed on Apr. 30, 2010 for LED has plurality of project means

This is patent application related to co-inventor's prior filing Ser. No. 12/711,456 Filed on Feb. 25, 2010 for LED power failure Light

This is patent application related to co-inventor's prior filing Ser. No. 12/710,561 Field on Feb. 25, 2010 for LED light device has special effects

This is patent application related to co-inventor's prior filing Ser. No. 12/710,918 Field on Feb. 25, 2010 for LED light device has more than 1 reflective means for plurality of image

This is patent application related to co-inventor's prior filing Ser. No. 11/24,2009 file for the “project device or assembly for variety of LED light”,

This is patent application related to co-inventor's prior filing Ser. No. 12/622,000 Field on Nov. 24, 2009 file for the “Interchangeable Universal Kits for all LED light”

This is patent application related to co-inventor's prior filing Ser. No. 12/318,471 Field Dec. 30, 2008 file for the “LED night light with pinhole imaging”

This is patent application related to co-inventor's prior filing Ser. No. 12/318,470 Field Dec. 24, 2008 file for the “LED night light with Projection features”

This is patent application related to co-inventor's prior filing Ser. No. 12/318,473 Field Dec. 8, 2008 file for the “LED night light with laser or hologram element”

This is patent application related to co-inventor's prior filing Ser. No. 12/292,153 Field Nov. 8, 2008 file for the “LED night light with Projection or imaging features”

This is patent application related to co-inventor's prior filing Ser. No. 12/232,505 Field Sep. 16, 2008 file for the “LED night light with Projection features”

This is patent application related to co-inventor's prior filing Ser. No. 12/149,963 Filed on Apr. 21, 2008 file for the “Removable LED light device.

This is patent application related to co-inventor's prior filing Ser. No. 12/149,964 Filed on Apr. 21, 2008 file for the “Surface Mounted Device with LED light”.

This is patent application related to co-inventor's prior filing Ser. No. 12/073,095 Filed on Feb. 29, 2008 file for the “LED Track light device.

This is patent application related to co-inventor's prior filing Ser. No. 12/073,889, filed on Feb. 12, 2008 file for the “LED light with changeable position with Preferable power source”.

This is patent application related to co-inventor's prior filing Ser. No. 12/007,076, filed on Jan. 7, 2008 file for the “LED light with changeable geometric system”

This is patent application related to co-inventor's prior filing Ser. No. 12/003,691, filed on Dec. 31, 2007 file for the “LED light with changeable geometric dimension features”

This is patent application related to co-inventor's prior filing Ser. No. 12/003,809, filed on Jan. 2, 2008 file for the “LED light with changeable features”

This is patent application related to co-inventor's prior filing Ser. No. 11/806,711 filed on Apr. 30, 2007 file for the “Multiple LED light with adjustable angle features”

This is patent application related to co-inventor's prior filing Ser. No. 11/806,285. LED Night light with outlet device filed on Apr. 30, 2007

This is patent application related to co-inventor's prior filing Ser. No. 11/806,284 LED Night light with more than 1 optics means filed on Apr. 28, 2007

This is patent application related to co-inventor's prior filing Ser. No. 11/527,628. Multiple function Night light with air fresher filed on Sep. 27, 2006.

This is patent application related to co-inventor's prior filing Ser. No. 11/527,629. LED Night light with interchangeable display unit filed on Sep. 27, 2006.

This is patent application related to co-inventor's prior filing Ser. No. 11/498,874. Area illumination Night light filed on Aug. 4, 2006.

This is patent application related to co-inventor's prior filing Ser. No. 11/527,631. LED Time piece night light field on Sep. 27, 2006.

This is patent application related to co-inventor's prior filing Ser. No. 12/545,992 LED time piece Night light filed division of Ser. No. 11/527,631 on Aug. 24, 2009.

This is patent application related to co-inventor's prior filing Ser. No. 12/292,580 LED Time Piece Night light filed division of Ser. No. 11/527,631 on Aug. 24, 2009.

This is patent application related to co-inventor's prior filing Ser. No. 11/498,881, Poly Night light filed on Aug. 4, 2006.

This is patent application related to co-inventor's prior filing Ser. No. 11/255,981, Multiple light source Night Light filed on Oct. 24, 2005.

This is patent application related to co-inventor's prior filing Ser. No. 11/184,771 Light Device with EL elements field on Oct. 11, 2005

This is patent application related to co-inventor's prior filing Ser. No. 11/1152,063 Outlet adaptor with EL field on Jun. 5, 2005

This is patent application related to co-inventor's prior filing Serial No.

This is patent application related to co-inventor's prior filing Ser. No. 11/094,215, filed Mar. 30, 2005 LED Night light with Liquid optics medium.

This is patent application related to co-inventor's prior filing Ser. No. 11/092,741, filed Mar. 30, 2005 Night light with fiber optics.

This is patent application related to co-inventor's prior filing Ser. No. 10/883,747, filed Jul. 6, 2004 Fiber Optic light kits for footwear.

This is patent application related to co-inventor's prior filing Ser. No. 11/498,874, Area Illumination for LED night light

This is patent application related to co-inventor's prior filing Ser. No. 11/527,629. Time Piece with LED night light,

This is patent application related to co-inventor's prior filing Ser. No. 11/527,628. Multiple Function Night light with Air Freshener

This is patent application related to co-inventor's prior filing Ser. No. 11/806,284 LED Night light with more than one optics mediums

This is patent application related to co-inventor's prior filing Ser. No. 11/806,285 LED Night Light with multiple function

This is patent application related to co-inventor's prior filing Ser. No. 11/806,711 Multiple LEDs Light with adjustable angle function

Above listed prior filing case related apply physic optic theory to the said LED light for outdoor or indoor application powered by alternative current (hereafter as AC) or direct current (hereafter as DC) connect by the electric cored & its plug for outlet, or battery, or transformer, or solar, or other power source which same as current invention to apply the physics optics theory to create plurality of LED light beam to make illumination for the said close area(s), or remote-away distanced-area(s) by said project means which present to viewers which may further incorporate with same inventor's other features which may in any combination from the selection including more than 1 light source, more than 1 function, more than 1 optics means, more than 1 project means with super power saving circuit and cost saving concept.

### BACKGROUND

US prior art none of any prior art has multiple functions as current invention, further more none of prior art has the project functions. LED Night light and moving proper density/weight floating miniatures staff as current invention and has details teach the propeller create the different directions and speed by proper input & output opening inside liquid container.

The US prior arts as below:

U.S. Pat. No. 4,072,855, U.S. Pat. No. 5,416,994 Liquid Display tube, U.S. Pat. No. 5,678,918 desk lamp pole, U.S. Pat. No. 6,517,231 Liquid stir, U.S. Pat. No. 6,877,883 water ball sphere, U.S. Pat. No. 7,905,728 Twiste watet ball tube, U.S. Pat. No. 7,909,477 (Co-inventor earlier patent), U.S. Pat. No. 7,784,959 Candle lite set, US 2006-0215-397, and US 2009-0135-586 all belong to motor/propeller applications but while use for different categories all are allow patents as above listed. However, the current invention has nothing to do with all these US prior arts on idea, applications for multiple function LED light as below discussion.

The current invention related to the LED Lava light which has no any toxic liquid material within the compartment. It also do not has the heater means which may cause big fire hazard while over heat happened. It is optional design to allow consumer to add the pure or good liquid into the container for alternative design so prevent airline carrier worry for liquid/fluid for dangerously concern.

The current invention for LED Lava Light use the motor incorporate with magnetic means to make the propeller rotating to make the liquid flow for desired directions and inner miniatures to move to make splendid motion moving for illumination and project light perforance, and also add more than one LED (co-inventors U.S. Pat. No. 7,455,444 patented) and more than one Optics means (co-inventor's U.S. Pat. No. 7,632,004) and U.S. Pat. No. 7,832,917 project Night light, U.S. Pat. No. 7,892,918 project Night light, U.S. Pat. No. 7,909,477 Aquarium Night light, U.S. Pat. No. 8,029,182 Aquarium Night light, U.S. Pat. No. 8,083,377 project Night light, U.S. Pat. No. 8,128,274 project Night light, U.S. Pat. No. 8,231,260 project Night light, U.S. Pat. No. 8,277,087 LED light more than one reflector means, U.S. Pat. No. 8,303,150 project LED light for Seasonal light, U.S. Pat. No. 8,303,158 LED light has special light effects, U.S. Pat. No. 8,408,736 LED light device has project light beams, U.S. Pat. No. 8,434,927 LED light has interchangeable power source. These issued patents still has a lot of CIP co-pending cases as below listed series number of parent of current invention.

The current invention overcome the (1) Toxic liquid (2) No heat hazard is big improvement for the LED Lava prior filing cases. Plusing add

(3) Project light performance to all desired areas

(4) More than one LEDs to make color changing light effects under built-in IC control for color, duration, sequential, flashing etc. functions available from market place.

(5) motor with design for liquid flow direction with input & output end opening and the opening small or big create the different fluid move for different liquid show as required including water dance, water wave, Aurora light effects project on desired location for multiple functions LED light unit

(6) motor rotating per minutes (hereafter as RPM) can program by the build-in IC or activate by the sound activated circuit or any motion, sensor, vibration, sound, remote control, infrad red control, switch means which from market available types.

(7) To add optics means such as convex lens, reflective lens, kaleidoscope means, laser means, hologram means, mirrors, lens or any optics related parts & Accessories will create more eye-catching effects, functions, performance.

The current multiple function project LED light has built-in motor means as CIP filing of co-pending project LED light and LED LAVA light_More than one LEDs +More than oneOptical means as listed on above.

The current invention also has below features including:

(8) Water Level Variabable for different functions:
While The liquid/fluid level almost full or high level than the Input & output openings->The liquid/fluid flow will like trend make the inner floating miniature staff or reflective particles or glitter to move up and down.
While the liquid/fluid level just over the input & output openings→The liquid/fluid passing though narrow cross-section areas for examples the narrow diameter so liquid/fluid speed will increase to high speed and make the peak(s) function like the water dance while use water for liquid/fluid.

It is appreciated the alternative application the liquid/fluid is not limited for water, oil, chemicals, compounds, smoke, it also can use solid particles or polyform parcicles or polylon balls, artificial plastic snow flakes or other solid particles, pieces, balls.

(9) Top of current inventions LED light has motor means which has build-in optics means on the TOP of the container to project the colorful changeable LED light beams, image, display units, geometric shape image to the desire locations including ceiling and walls.

This is unique and under co-inventor's multiple issued or co-pending filing for variety and alternative skill to project LED light beams, display image as above listed as prior arts and should put into consideration for current inventions scope and not limited for claims.

(10) Circuit means create the different LED light show, time of show, duration, Function, motor RPM though traditional or conventional market available IC technical and control means, switch means, sensor means, trigger means to make the said LED light device has eye-catching light effects, moving staff, Project light beams, project image from current invention products.

(11) Power supply for current LED light which has motor means and project functions and moving staff/particle/liquid functions. The power may selected from any combination from Plug-in Prong means, USB-power with USB kits, adaptor type with UL listed transformer, battery pack with preferred kits, co-inventor's interchangeable power source means or any other energy soure or strage means for current invention.

(12) Multiple function which including project function, Moving staff function, LED light function as co-ending or co-inventor's issued patents.

### BRIEF DESCRIPTION OF THE DRAWINGS

FIGS. 1, 2-5, 3-5, and 4-3 to 4-5 are perspective views of a night light with a liquid container as disclosed in the inventor's copending application.

FIG. 2 is a perspective views of a night light with a liquid container according to a preferred embodiment of the present invention.

FIGS. 2-1 to 2-2 are side views of the night light of FIG. 2.

FIGS. 2-3 to 2-4 are additional perspective views of the night light of FIG. 2.

FIG. 3 is a perspective view of a night light with a liquid container according to another preferred embodiment of the present invention.

FIGS. 3-1 to 3-2 are side views of the night light of FIG. 3.

FIGS. 3-3 to 3-4 are additional perspective views of the night light of FIG. 3.

FIGS. 4 and 4-1 are perspective views of a liquid moving mechanism for use in the preferred night lights.

FIG. 4-2 is a top view of the mechanism of FIGS. 4 and 4-1.

FIGS. 5 and 5-1 to 5-4 are perspective views showing variations of the mechanism of FIGS. 4 and 4-1.

FIGS. 6 and 6-1 are perspective views showing variations of the mechanism of FIGS. 4 and 4-1.

### ADDITIONAL DESCRIPTION OF THE DRAWINGS

Page 6+7+8+9: Diclosure co-pending filing 4 page drawings

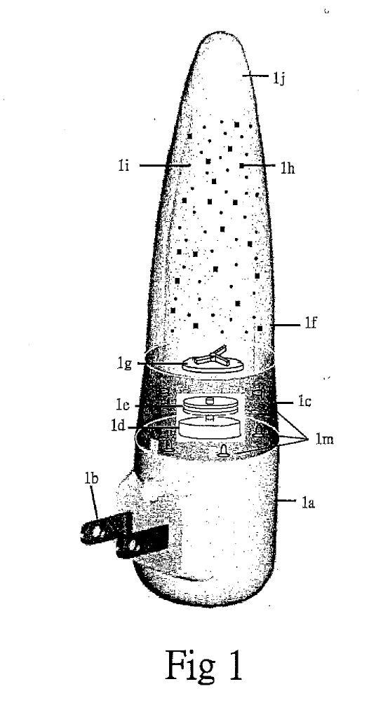

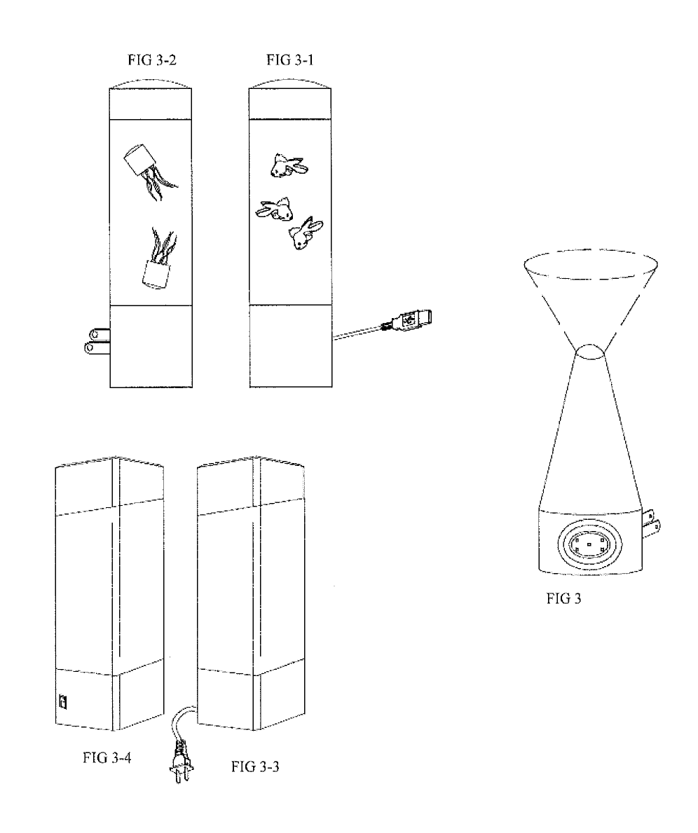

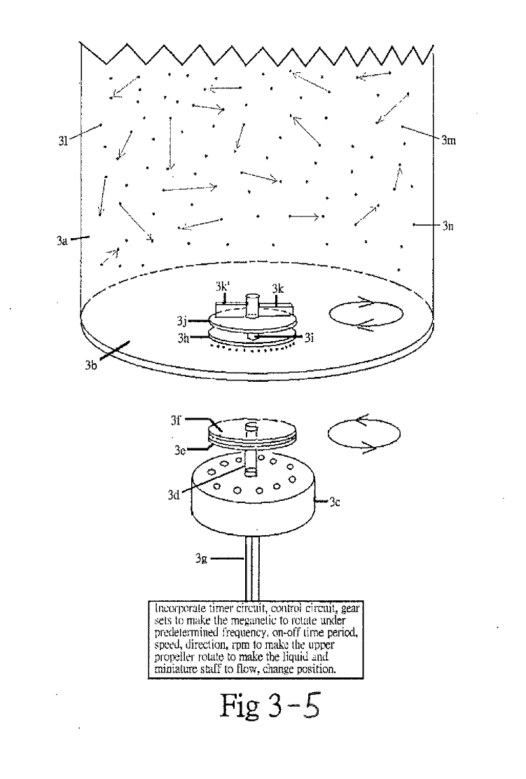

FIG. 1 and FIG. 3: Disclosure the 1^{st} embodiment with liquid container has propeller and magnetic means to make few amount of the liquid/fluid flow with high speed injection to create water peaks and make inside few amount of liquid/fluid moving, the motor are control by preferred IC means or circuit means has magnetic means to make reaction to propeller's magnetic means so can rotating and make the fluid flow on desire direction(s) and certain period of time. The build-in LED(s) and circuit means to make the said LED emit the pre-determined function, color, brightness and may incorporated with optics means on top of container to project the desire image or light beams with color changing performance.

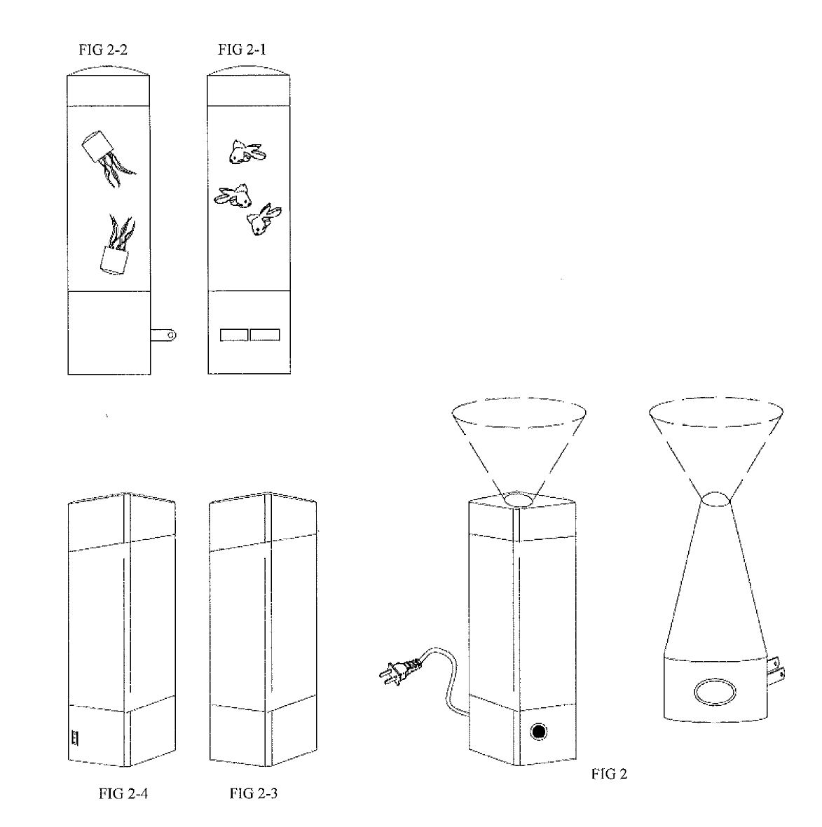

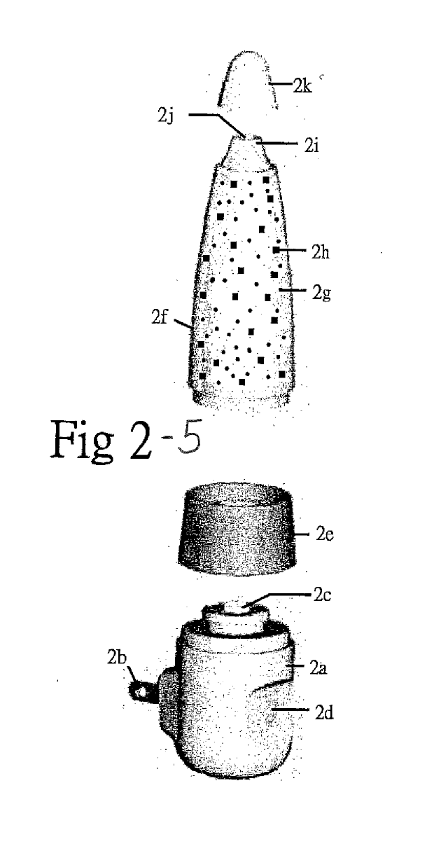

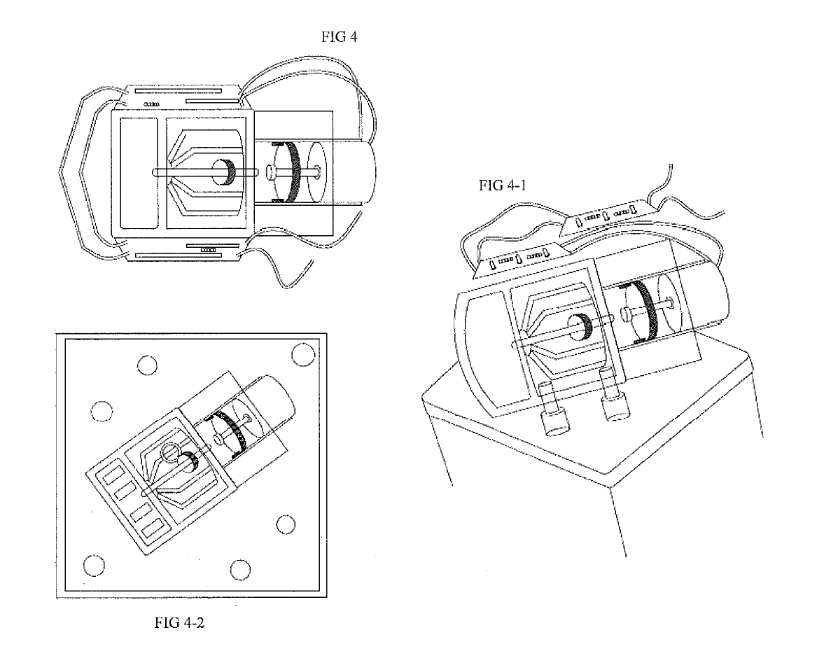

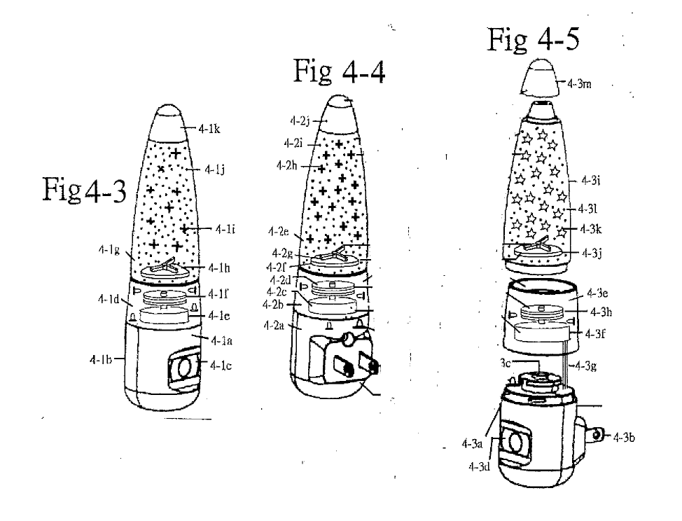

FIG. 2 and FIG. 2-1, FIG. 2-2, FIG. 2-3, FIG. 2-4, FIG. 3-1, FIG. 3-2, FIG. 3-3, FIG. 3-4: Disclosure the 2nd^{t} embodiment with liquid container has propeller and magnetic means to make almost big amount of the liquid/fluid flow with slow speed water trend come out from output opening(s) to create water trend with slow speed because the water come out from Big output openings and water come out right away into high level liquid/fluid so make inside liquid/fluid moving slowly, the motor are control by preferred IC means or circuit means and sensor means, switch means, trigger means, activate means and motor has magnetic means to make reaction to propeller's magnetic means so can rotating and make the fluid flow on desire direction(s) and certain period of time. The build-in LED(s) and circuit means to make the said LED emit the pre-determined function, color, brightness and may incorporated with optics means on top of container to project the desire image or light beams with color changing performance.

FIG. 4 and FIG. 4-1 and FIG. 4-2: Disclosure the detail construction of the preferred embodiment 2. Show the liquid container, mortor means, propeller means, 1^{st} magnetic means, 2^{nd} magnetic means, PCB 1, PCB 2, PCB hold pole, Base of container, motor axis, propeller axis, input & output opening(s), light passing piece, LED, Base, sensor means, electic means and inner circuit means. The container has variety design of miniatures staff, liquid/fluid/particles/air/glitters which may in round piece, rectangular pieces, star shape, heart shape, cartoon characters or any geometric shapes. The light passing piece can be transparent or translucent material basing on market requirement. The LED number can be from one to N (Any number) for desired light performance. Also show details preferred construction for the slow flow trend to make the inner staff for moving for certain directions with projection to desire locations. It also, Disclosure the propeller and magnetic piece has base which glue on the bottom of liquid container. The propeller and magnetic piece are reactive by the motor & its magnetic piece which install on the outside of the liquid container. The motor incorporate with control means to make certain speed and rotating time and duration for rotating so make the inner miniature or liquid/fluid/particles/air/chemical/compound move in right speed to desired directions to make eye catching motion effects of miniatures staff.

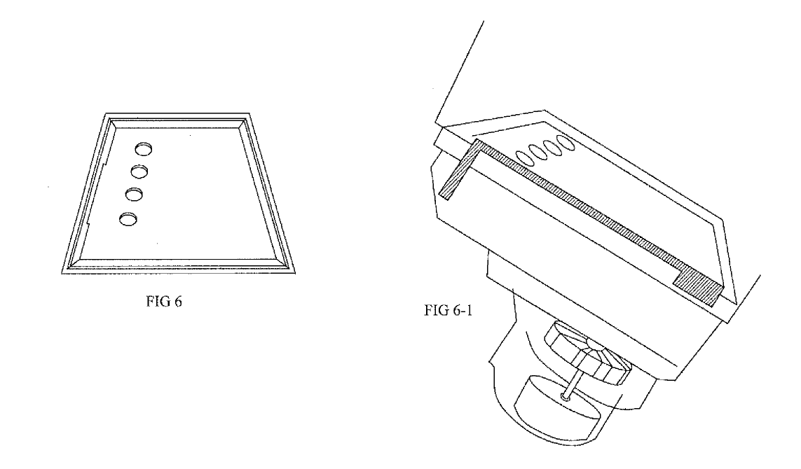

FIG. 5 and FIG. 5-1 and FIG. 5-2 and FIG. 6 and FIG. 6-1: Disclosure the detail construction of the preferred embodiment 1. Show the liquid container, mortor means, propeller means, 1^{st} magnetic means, 2^{nd} magnetic means, PCB 1, PCB 2, PCB hold pole, Base of container, motor axis, propeller axis, input & BIG output opening(s), light passing piece, LED, Base, sensor means, electic means and inner circuit means. The container has variety design of miniatures staff, liquid/fluid/particles/air/glitters which may in round piece, rectangular pieces, star shape, heart shape, cartoon characters or any geometric shapes. The light passing piece can be transparent or translucent material basing on market requirement. The LED number can be from one to N (Any number) for desired light performance. Also show details preferred construction for the tiny Output openings which make the quickly speed of liquid injection from tiny output opening(s) to make water peak(s) to make the water dance under pre-determind motor speed control by conventional IC means or sensor means, variable electric means, trigger means, or other electric parts & accessories.

It also, Disclosure the propeller and magnetic piece has base which glue on the bottom of liquid container. The propeller and magnetic piece are reactive by the motor & its magnetic piece which install on the outside of the liquid container. The motor incorporate with control means to make certain speed and rotating time and duration for rotating so make the inner miniature or liquid/fluid/particles/air/chemical/compound move in right speed to desired directions to make eye catching motion effects of miniatures staff

FIG. 3-4: Disclosure the Battery Powered LED light which has at least motion moving of miniature staff to desired path and directions and build-in night light or project light and the motor means incorporate with magnetic means. The inner minatures here as chemicals or particles so can move like Vacano.

FIG. 3-3: Disclosure the AC powered LED light which has at least motion moving of miniature staff and build-in night light or/and project light and the motor means incorporate with magnetic means. The inner minatures here as glitter or reflective particles, reflective piece which has certain density v.s. the inner liquid/fluid so can make floating within the liquid/fluid medium.

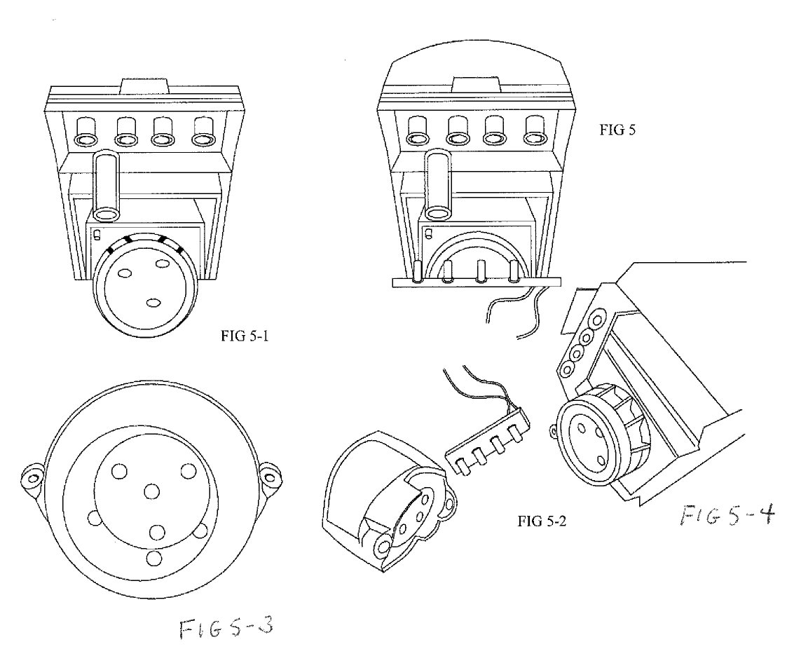

FIG. 4-1, FIG. 5, FIG. 5-1, FIG. 5-2: Disclosure the AC powered LED light which has details construction and at least has more than one LED and more than one optics means and more one reflective means to make the current invention LED light has more than one LED emit light beams to different direction which same as co-inventor's prior filing case for illuminated the container and project the light beams though Optics means on top of the said container.

### Detail Description

FIG. 1 and FIG. 3: Disclosure the 1^{st} embodiment with liquid container has propeller and magnetic means to make few amount of the liquid/fluid flow with high speed injection to create water peaks and make inside few amount of liquid/fluid moving, the motor are control by preferred IC means or circuit means has magnetic means to make reaction to propeller's magnetic means so can rotating and make the fluid flow on desire direction(s) and certain period of time. The build-in LED(s) and circuit means to make the said LED emit the pre-determined function, color, brightness and may incorporated with optics means on top of container to project the desire image or light beams with color changing performance.

FIG. 2 and FIG. 2-1, FIG. 2-2, FIG. 2-3, FIG. 2-4, FIG. 3-1, FIG. 3-2, FIG. 3-3, FIG. 3-4: Disclosure the 2nd^{t} embodiment with liquid container has propeller and magnetic means to make almost big amount of the liquid/fluid flow with slow speed water trend come out from output opening(s) to create water trend with slow speed because the water come out from Big output openings and water come out right away into high level liquid/fluid so make inside liquid/fluid moving slowly, the motor are control by preferred IC means or circuit means and sensor means, switch means, trigger means, activate means and motor has magnetic means to make reaction to propeller's magnetic means so can rotating and make the fluid flow on desire direction(s) and certain period of time. The build-in LED(s) and circuit means to make the said LED emit the pre-determined function, color, brightness and may incorporated with optics means on top of container to project the desire image or light beams with color changing performance.

FIG. 4 and FIG. 4-1 and FIG. 4-2: Disclosure the detail construction of the preferred embodiment 2. Show the liquid container, mortor means, propeller means, 1^{st} magnetic means, 2^{nd} magnetic means, PCB 1, PCB 2, PCB hold pole, Base of container, motor axis, propeller axis, input & output opening(s), light passing piece, LED, Base, sensor means, electic means and inner circuit means. The container has variety design of miniatures staff, liquid/fluid/particles/air/glitters which may in round piece, rectangular pieces, star shape, heart shape, cartoon characters or any geometric shapes. The light passing piece can be transparent or translucent material basing on market requirement. The LED number can be from one to N (Any number) for desired light performance. Also show details preferred construction for the slow flow trend to make the inner staff for moving for certain directions with projection to desire locations. It also, Disclosure the propeller and magnetic piece has base which glue on the bottom of liquid container. The propeller and magnetic piece are reactive by the motor & its magnetic piece which install on the outside of the liquid container. The motor incorporate with control means to make certain speed and rotating time and duration for rotating so make the inner miniature or liquid/fluid/particles/air/chemical/compound move in right speed to desired directions to make eye catching motion effects of miniatures staff.

FIG. 5 and FIG. 5-1 and FIG. 5-2 and FIG. 6 and FIG. 6-1: Disclosure the detail construction of the preferred embodiment 1. Show the liquid container, mortor means, propeller means, 1^{st} magnetic means, 2^{nd} magnetic means, PCB 1, PCB 2, PCB hold pole, Base of container, motor axis, propeller axis, input & BIG output opening(s), light passing piece, LED, Base, sensor means, electic means and inner circuit means. The container has variety design of miniatures staff, liquid/fluid/particles/air/glitters which may in round piece, rectangular pieces, star shape, heart shape, cartoon characters or any geometric shapes. The light passing piece can be transparent or translucent material basing on market requirement. The LED number can be from one to N (Any number) for desired light performance. Also show details preferred construction for the tiny Output openings which make the quickly speed of liquid injection from tiny output opening(s) to make water peak(s) to make the water dance under pre-determined motor speed control by conventional IC means or sensor means, variable electric means, trigger means, or other electric parts & accessories.

It also, Disclosure the propeller and magnetic piece has base which glue on the bottom of liquid container. The propeller and magnetic piece are reactive by the motor & its magnetic piece which install on the outside of the liquid container. The motor incorporate with control means to make certain speed and rotating time and duration for rotating so make the inner miniature or liquid/fluid/particles/air/chemical/compound move in right speed to desired directions to make eye catching motion effects of miniatures staff.

FIG. 3-4: Disclosure the Battery Powered LED light which has at least motion moving of miniature staff to desired path and directions and build-in night light or project light and the motor means incorporate with magnetic means. The inner minatures here as chemicals or particles so can move like Vacano.

FIG. 3-3: Disclosure the AC powered LED light which has at least motion moving of miniature staff and build-in night light or/and project light and the motor means incorporate with magnetic means. The inner minatures here as glitter or reflective particles, reflective piece which has certain density v.s. the inner liquid/fluid so can make floating within the liquid/fluid medium.

FIG. 4-1, FIG. 5, FIG. 5-1, FIG. 5-2: Disclosure the AC powered LED light which has details construction and at least has more than one LED and more than one optics means and more one reflective means to make the current invention LED light has more than one LED emit light beams to different direction which same as co-inventor's prior filing case for illuminated the container and project the light beams though Optics means on top of the said container.

1. The LED light consist:
At least one of the container has receiving a plurality of miniatures staff(s) or fluid or liquid or chemical or particles or solid pieces inside with desire colorful or reflective properties.
At least one of the propeller has 1st magnetic means and base which fix on the inner bottom of the said liquid container. The said propeller means can be freely rotate on base with tiny resistance to make the liquid, water, fluid, air, chemical, particles to move to desire directions and speed.
At least one of the 2nd magnetic means on base are fix on the axis of the motor means and motor means are rotate under pre-determined speed, rotating per second, frequency, duration by control means including IC means or other circuit means, electric parts & accessories.
The 2^{nd} magnetic means rotate will activate the 1^{st} magnetic means to make the propeller rotating under desired function.
The rotating propeller will make liquid f/fluid/checmical/particles/solid pieces's flow move and make the miniatures staff/fluid/liquid/air/chemical/particles/solid piece to desire direction(s) moving accordingly to moving direction(s) and speed so can make motion moving effects.
At least one of LED(s) to emit light beam to illuminated the container and at least one of 2^{nd} LED(s) to emit light beam to make the project light beams or image performance. The said LED light has prong means to connect with outlet or the said LED light has self-power or outside power which may selected from group combination including batteries, USB wire and kits, adaptor, transformer, energy storage parts and accessories, solar module, wind power, chemical power or other energy forms available from market place.
The said LED light has optics means can project or enlarge the liquid or minature staff or reflectors or glitter or chemical or solid piece or light beams or display means to has desire image to been seen on desire locations, areas including ceiling, walls, floor, fence and other surface(s).
The improvement including:
The said LED light has multiple functions including moving staff/particles/chemical, liquid/fluid/solid piece/minature staff for inner staff moving and project light or optional other added functions which may in ground combination selected from;
(1) water dance,
(2) really water wave image projection,
(3) minatures moving on desired speed and directions,
(4) air/smoke/chemical/particles/solid piece flow moving,
(5) turnato spin fluid moving
(6) extra light show including Aurora light performance by LEDs and optics means
(7) additional LED light functions
with preferred combination for parts & accessories selected from
(a) liquid input & output opening(s) for container, the big or small output opening to make the liquid/fluid/particles/come out for slow water fountain very slow trend or strong liquid/fluid/particles inject out from tiny opening to make peak(s) like water dance performance,
(b) smoke or chemical mix or particles or plastic made solid piece(s) for special effects,
(c) miniature moving up & down need proper arrange the density and weight of the said miniature staff v.s. liquid,
(d) The propeller move the liquid has desire input and output opening
(e) Light show while incorporated with optics means to make the image project though project means to desired location.
(f) Optional additional functions for light functions incluidng LED night light, motion sensor Night light, Power fail night light, photo sensor night light.

2. The LED light consist of;
At least one LEDs incorporate with container, transparent or translucent piece, safety approval LED base, and top cover to form a LED light.
The improvement including:
The said LED light may consist of desired parts and accessories Selected from group combination of motor means, propeller means, desire size of input & output openings inside container, 1st magnetic means, 2^{nd} magnetic means, timer means, IC means, circuit means, trigger means, sensor means, switch means, USB means and kits, project means, display means, more than one LEDs, energy storage means, batteries, prong means, conductive means, free moving base with axis, circuit means, control means, miniature staff, liquid/fluid/solid piece/chemical/ in variety designs and size.
The said LED light's miniatures stuff/liquid/fluid/solid piece/chemical/ will moving while the said light be powered by prong means or battery means to drive the motor rotating under per-determined on and off per period of time to drive the 2^{nd} magnetic means to active 1^{st} magnetic means to make propeller make liquid moved.
The said LED light has project LED light beam or display means image to desired locations and areas.
